(19) United States
(12) Patent Application Publication
(10) Pub. No.: US 2017/0308841 A1
(43) Pub. Date: Oct. 26, 2017

(54) Predictive Analytics System Using Current And Historical Role Information

(71) Applicant: CEB Inc., Arlington, VA (US)

(72) Inventors: Vijayakumar Swaminathan, The Woodlands, TX (US); Vamsee Kumar Tirukkala, The Woodlands, TX (US)

(21) Appl. No.: 15/493,465

(22) Filed: Apr. 21, 2017

Related U.S. Application Data
(60) Provisional application No. 62/325,554, filed on Apr. 21, 2016.

(51) Int. Cl. G06Q 10/06; G06Q 10/10; G06N 5/04

(52) U.S. Cl. CPC G06Q 10/063112; G06N 5/04; G06Q 10/1053

(57) ABSTRACT

Methods, systems, and apparatus, including computer programs encoded on computer storage media, for determining changes in job skills. One of the methods includes identifying workers who have had a particular job role, determining different sets of workers, for each of the different periods of time: determining skills of the worker during the period of time, determining skills in common for the workers that had the particular job role during the period of time, and selecting a representative set of skills for the job role at the period of time, evaluating the representative sets of skills to identify differences among the representative sets of skills for the particular job role corresponding to the different periods of time, and selecting a predicted set of skills for the particular job role that represents the skills that will be required for the particular job role at a particular time in the future.

### CROSS-REFERENCE TO RELATED APPLICATION

This application claims the benefit of U.S. Provisional Application No. 62/325,554, filed on Apr. 21, 2016, the contents of which are incorporated by reference herein.

### BACKGROUND

This specification relates to predictive analysis using current and historical data about job roles.

In companies and other organizations, different job roles often require different sets of skills. For example, an accountant and a programmer generally need different skills to perform their respective duties. The skills that a person needs to be effective in a particular role may change over time.

### SUMMARY

In some implementations, a computing system analyzes information about organizations and workers to predict how a particular role will change over time, e.g., how the skills required for the role will change. The system may use the prediction of the changes to the role to determine training for employees in the particular role, e.g., to provide the employees with the skills they do not currently have or need, but may need for the particular role at a future date. The system may use the prediction to determine where to build an office to take advantage of labor markets that are predicted to have workers with the skills necessary for the positions at the office. In some examples, the system may use a prediction for a role to determine how good of a fit a job applicant is for a particular role.

In general, one innovative aspect of the subject matter described in this specification can be embodied in methods that include the actions of identifying, by a computing system in communication with one or more data storage devices storing records indicating job roles and skills of individual workers, workers who have had a particular job role, determining, by the computing system and from among the identified workers who have had the particular job role, different sets of workers wherein each set corresponds to a different period of time and identifies workers that had the particular job role during the corresponding period of time, for each of the different periods of time: determining, by the computing system and for each worker in the set of workers that had the particular job role during the period of time, skills of the worker during the period of time, comparing, by the computing system, the skills determined for the workers that had the particular job role during the period of time to determine skills in common for the workers that had the particular job role during the period of time, and selecting, by the computing system and using the skills in common for the workers that had the particular job role during the period of time, a representative set of skills for the job role at the period of time, the representative set of skills including skills most commonly possessed by workers having the particular job role during the period of time, evaluating, by the computing system, the representative sets of skills to identify differences among the representative sets of skills for the particular job role corresponding to the different periods of time, and based on identified differences among the representative sets of skills, selecting, by the computing system, a predicted set of skills for the particular job role that represents the skills that will be required for the particular job role at a particular time in the future. Other embodiments of this aspect include corresponding computer systems, apparatus, and computer programs recorded on one or more computer storage devices, each configured to perform the actions of the methods. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. The method may include determining, for each worker in the set of workers that has the particular job role during a current period of time, second skills of the worker, comparing the second skills determined for the workers that have the particular job role during the current period of time to determine second skills in common for the workers that have the particular job role during the current period of time, selecting, using the second skills in common for the workers that have the particular job role during the current period of time, a current representative set of skills for the job role at the current period of time, and comparing the predicted set of skills with the current representative set of skills to determine predicted new skills required for the particular job role at the particular time in the future.

In some implementations, the method may include identifying current skills for a particular worker, determining, for each of the predicted new skills and using the current skills of the particular worker, a likelihood that the particular worker will have or can learn the predicted new skill, determining, for each of the predicted new skills, whether the likelihood that the particular worker will have or can learn the predicted skill satisfies a threshold value, determining, using the likelihoods that the particular worker will have or can learn each of the predicted skills, a probability that the particular worker will qualify for the particular job role at the particular time in the future, and providing instructions for presentation of a user interface with information about the probability that the particular worker will qualify for the particular job role at the particular time in the future. Determining the likelihood that the particular worker will have or can learn the predicted new skill may include determining a set of comparison workers each of which (i) has each of the skills in the current representative set of skills and (ii) previously did not have one of the skills in the current representative set of skills, comparing characteristics of the particular worker with characteristics of the comparison workers to determine a degree of similarity between the characteristics of the particular worker and the characteristics of the comparison workers, and determining the likelihood that the particular worker will have or can learn the predicted new skill using the degree of similarity between the characteristics of the particular worker and the characteristics of the comparison workers. Determining the likelihood that the particular worker will have or can learn the predicted new skill may include determining, for each worker in a particular set of workers that have had the particular job role, whether a set of skills for the worker has changed over time, comparing the characteristics of the particular worker with characteristics of the workers that each has a set of skills that changed over time to determine a degree of similarity between the characteristics of the particular worker and the characteristics of the workers in the particular set, and determining the likelihood that the particular worker will have or can learn the predicted new skill using the degree of similarity between the characteristics of the particular worker and the characteristics of the workers in the particular set.

In some implementations, determining, for each of the predicted new skills using the current skills of the particular worker, the likelihood that the particular worker will have or can learn the predicted new skill may include determining, for each worker in a group of workers and for each of the predicted new skills, a likelihood that the worker will have or can learn the predicted new skill. Identifying the current skills for the particular worker may include identifying the current skills of a prospective employee. Determining, for each of the predicted new skills and using the current skills of the particular worker, the likelihood that the particular worker will have or can learn the predicted new skill may include determining which skills in the current representative set of skills the prospective employee has, and determining, for each of the predicted new skills, a likelihood that the prospective employee will have or can learn the predicted skill using the skills in the current representative set of skills that the prospective employee has and background information of the prospective employee. Determining, for each of the predicted new skills using the current skills of the particular worker, the likelihood that the particular worker will have or can learn the predicted new skill may include determining, for each of the predicted new skills, the likelihood that the particular worker will have or can learn the predicted skill using one or more of an education of the particular worker, a geographic location in which the particular worker lives, or a job history of the particular worker. The method may include providing, for each of the predicted new skills that (i) has a respective likelihood that satisfies the threshold value and (ii) is not one of the current skills of the particular worker, instructions for presentation of a user interface with information about an activity in which the particular worker can participate to acquire the predicted skill.

In some implementations, the method may include identifying, from records indicating job descriptions, a set of job descriptions for the particular job role, and determining, for each job description in the set of job descriptions, one of the different periods of time during which the job description was posted. Selecting, for each of the different periods of time, the representative set of skills for the job role at the period of time may include determining, for each of the job descriptions for the period of time, second skills listed on the job description, comparing the second skills to determine second skills in common for the job descriptions for the period of time, and selecting the representative set of skills for the job role at the period of time using the second skills in common between the job descriptions for the period of time. Selecting the representative set of skills for the job role at the period of time may include determining, for each of the skills determined for the workers that had the particular job role during the period of time, whether a measure of workers who had the skill satisfies a threshold value, and including, for each of the skills for which a measure of workers who had the skill satisfied the threshold value, the skill in the representative set of skills for the job role at the period of time.

In some implementations, evaluating the representative sets of skills to identify the differences among the representative sets of skills for the particular job role corresponding to the different periods of time may include determining a frequency at which changes to the representative set of skills for the particular job role occurred over the different periods of time. Selecting the predicted set of skills for the particular job role that represents the skills that will be required for the particular job role at the particular time in the future may include determining, using the frequency at which the changes to the representative set of skills occurred over the different periods of time for each skill in the representative sets of skills, a likelihood that the skill will be required for the particular job role at the particular time in the future, and determining, for each of the skills, whether the likelihood satisfies a threshold value, and selecting, for each of the skills with a respective likelihood that satisfies the threshold value, the skill as a predicted skill in the predicted set of skills.

The subject matter described in this specification can be implemented in particular embodiments and may result in one or more of the following advantages. In some implementations, a system may determine one or more predicted job role skills for a particular time in the future. In some implementations, a system may determine a recommended location at which to open a location, a recommendation about training for one or more workers, or both. In some implementations, a system may automatically schedule training, automatically provide training, or both, to a worker using predicted job role skills for the worker. For instance, in response to determining a predicted job role skill for a worker, the system may cause the generation and automatic presentation of a user interface with training information about the predicted job role skill. The system may cause the automatic presentation of the user interface on a device operated by the worker.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is an example of an environment in which a system predicts a set of skills required for a particular job role at a future date.

FIG. 2 is an example of a job role analysis system that predicts skills likely to be required for a job role in the future.

FIG. 3 is a flow diagram of a process for selecting a predicted set of skills for a particular job role.

FIG. 4 is a flow diagram of a process for determine predicted new skills required for a particular job role at a particular time in the future.

Like reference numbers and designations in the various drawings indicate like elements.

### DETAILED DESCRIPTION

In some implementations, an analysis system uses information about different workers to predict the skills that will be needed in the future for particular job roles. The requirements of a particular job role may change over time. The changes may occur for various reasons, such as changes in technology or changes in the nature of tasks required in the role. For instance, a data entry position may require entry of data using a typewriter at one time. Some years later, the same data entry position may require data entry using a computer, e.g., entry of data into a document or spreadsheet, and even later still may require data entry using a computer database application. Thus, the job role for a typical “data entry worker” may require a different skill set at different points in time.

The analysis system can use information about the skills and job roles of many individual workers to predict how job roles will change over time. For example, the analysis system can identify workers in different companies who each have the same job role. The analysis system can determine what skills are most common for the job role, and see how those skills compare to the skills that were common for the job role in previous time periods. From this and other information, the system can predict what skills are likely to be needed for a job role at some time in the future, e.g., one year, five years, or ten years later.

For a given job role, the system can determine customized predictions for specific industries or companies. For example, an attorney in the semiconductor industry may be likely to need different skills than an attorney at a pharmaceutical company.

The predictions of the system may be used to enhance planning and worker training. For example, knowing the future needs of a job role, companies can adjust hiring criteria to hire employees that are more likely to meet the future needs and not just current needs. Similarly, current workers in an organization can be assessed to determine how many individual workers within the organization are candidates to remain in or transition to a job role given the likely changes in the requirements for the job role that will likely occur.

In some examples, individual workers can be assessed to determine what training is needed so that the worker will have the needed skills in the future. Additionally, organizations can use the predicted job role information to decide where to locate facilities so that the chosen location provides an appropriate base of skilled workers with appropriate labor costs. For example, organizations can obtain information about the labor pool in different cities, states, and countries to compare characteristics of potential workers and identify where facilities and jobs can be located.

An entity may want to know a predicted set of skills for a job role at a future date. For instance, a company may want to know what skills will be required in order to provide training to its employees to prepare them to perform effectively in the future. A company may want to know whether a particular worker or group of workers is likely to have the skills required for a particular job role at the future date. Similarly, a company may want to determine a quantity of workers in a particular area that are likely to have the skills required for a particular job role at the future date.

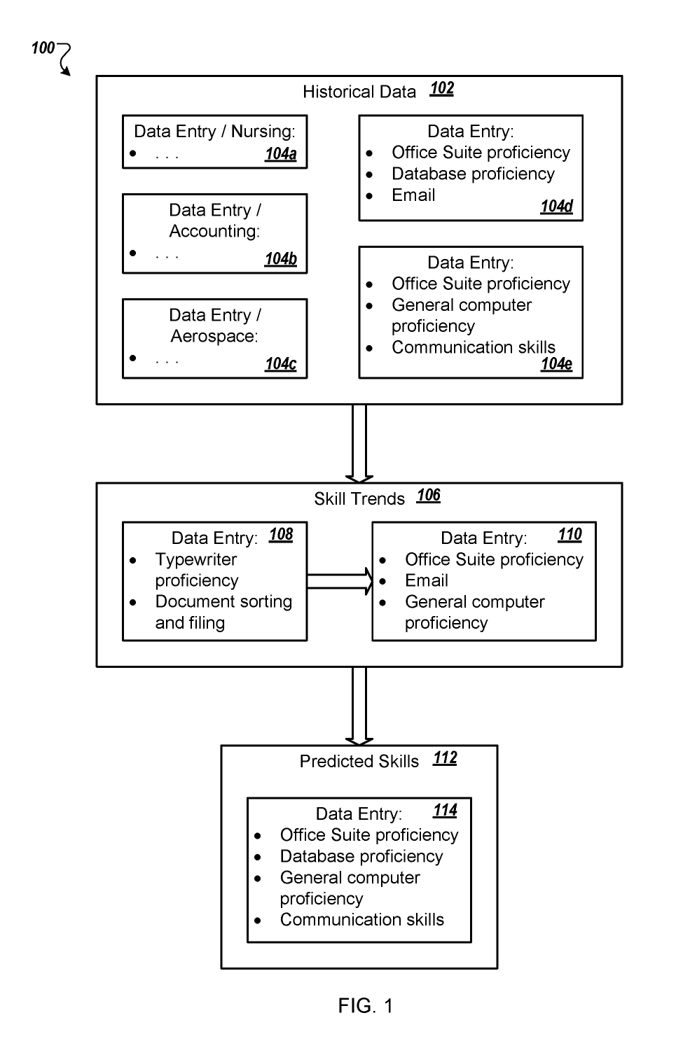

FIG. 1 is an example of an environment 100 in which a system predicts a set of skills 112 required for a particular job role at a future date. The system uses historical data 102, such as data 104a-e that identifies skills that particular workers had at particular times and for particular job roles, to determine the predicted set of skills 112.

For instance, the system analyzes the historical data 102 to determine a subset of the historical data 102 that includes only skills for workers in a particular job role, such as data entry, and not data for workers in other job roles. In the example of FIG. 1, the subset of historical data includes different lists 104a-e, and each list 104a-e is a list of skills of a different person that has or had the particular job role. The workers can be in different industries. For example, a first list 104a for a person in a data entry position in nursing, a second list 104b for a person in a data entry position in accounting, and a third list 104c for a person in a data entry position in aerospace. The subset of historical data 102 may include lists for the particular job role that do not identify a particular industry, such as a fourth list 104d and a fifth list 104e.

All of the lists include, in addition to the title of the job role, skills a corresponding worker had while working in the job role. Some examples of skills for the data entry job role may include Office Suite proficiency, database proficiency, general computer proficiency, email, and communication skills. Each of the lists 104a-e may include different combinations of skills. For instance, all of the lists 104a-e may indicate that the corresponding worker had Office Suite proficiency, the second list 104b for a data entry worker in accounting may indicate that the worker had experience with a spreadsheet application and accounting software, the fourth list 104d may indicate that a worker had database proficiency, and the fifth list 104e may indicate that a corresponding worker had good communication skills.

Some or all of the historical data 102 may include date information. For instance, the first list 104a may include a start date indicating the date on which the worker started the data entry job in nursing. The second list 104b may include a date range, indicating both the start date and the end date, for the time during which the worker had the data entry job in accounting. The fourth list 104d may include an end date indicating the date on which the worker stopped working the particular data entry job, e.g., to start a different data entry job or a job with a different role other than data entry.

The system determines skill trends 106 for job roles. In the illustrated example, the system determines trends in the skills of workers in a particular job role, e.g., data entry. The system may perform the determination multiple times for different job roles, different industries, different geographic locations, or combinations of these.

For example, the system determines first common skills 108 for the particular job role during a first period of time, e.g., twenty to thirty years ago. The first common skills 108 for the first period of time for a data entry job role may include typewriter proficiency and document sorting and filing. The system also determines second common skills 110 for the particular job role during a second period of time, e.g., ten to twenty years ago, during the past ten years, or both separately. For instance, the second common skills 110 for the second period of time for a data entry job role may include Office Suite proficiency, email, and general computer proficiency.

The system uses the first common skills 108 and the second common skills 110, potentially with other sets of common skills for other time periods, to determine skill trends 106 for the particular job role. In some examples, the system may determine changes to the skills required for the particular job role, how often those changes occurred, correlations between those changes and changes to technology, and other types of trend information for the particular job role. The system may use any appropriate methods to determine the trends.

The system uses the skill trends 106 for the particular job role to determine predicted skills 112 for the particular job role. The system may determine, using the skill trends 106, that some current workers in the particular job role have certain skills that none of the previous workers in the particular job role had and those certain skills are likely to be required for the job role in the future. For example, the system may determine that a threshold quantity of data entry workers have database proficiency, that database proficiency is not one of the current common skills 110 for data entry workers, and that data entry positions in the future are likely to require database proficiency.

In some implementations, the system determines how frequently new skills are added to a job role (e.g., every year, or every five years, etc.). The system may determine a score that indicates how frequently new skills are added to a job role. Some job roles, such as software engineer, may have frequently changing skill sets, while other job roles, such as customer service representative, may have skill requirements the change less frequently. The system can use the historical rate of skill change for a job role or set of job roles to predict the rate of future changes. For example, the system may linearly extrapolate the most an average rate of skill change for a job role, e.g., if three new skills were typically added every five years, then three new skills for the job role would be predicted for a time period in the future. As another example, if analysis of prior time periods indicates that the rate of skill changes has been increasing for a job role or industry, the system can use a non-linear prediction that reflects an increasing rate of skill change, e.g., with three or four new skills predicted over the next five years, even if only one or two new skills were added during the previous five years.

In some implementations, the system may also identify a type change in skill that is occurring. New skills may be selected according to a hierarchy of skills or set of categories, for example, to indicate more specialized or more advanced proficiency in areas relevant to the corresponding job role. As another example, the analysis of data for workers having the job role may indicate a subset of the workers (e.g., 10%, 20%, etc.) that are high performers or that tend to acquire skills that later become common for the job role. The new skills that these workers gain may be inferred to represent likely changes for others in the same job role or a similar job role.

As another example, the system may use trends for organizations, industries, or geographical areas. For example, the system may determine that an industry is becoming increasingly computerized, since many job roles are adding computer proficiency as a skill, and so the data entry role will also likely require additional computer proficiency. The system may also compare skill sets for different job roles to detect how roles shift and transition. For example, the system may determine overlap between the current or former skills needed for a job role with the current and former skills needed for other job roles. For instance, the system may determine that a current product engineer role has added skills typically associated with a prior marketing role. As a result, the system may predict that the product engineer may continue to add skills from the marketing role in the future.

As discussed in more detail below, the system can present information about the predicted skills 112 to a user, e.g., a manager, determine training that may enable current workers to learn the predicted skills 112 needed to remain effective in their job role in the future. Similarly, the predicted skills 112 may be used to identify skills for a particular job role that the current workers do not have, or to determine a particular geographic area in which there is likely to be a predetermined quantity of workers with the predicted skills 112 at a future date, e.g., who can work at a new store or building. The predictions can be used for various other purposes.

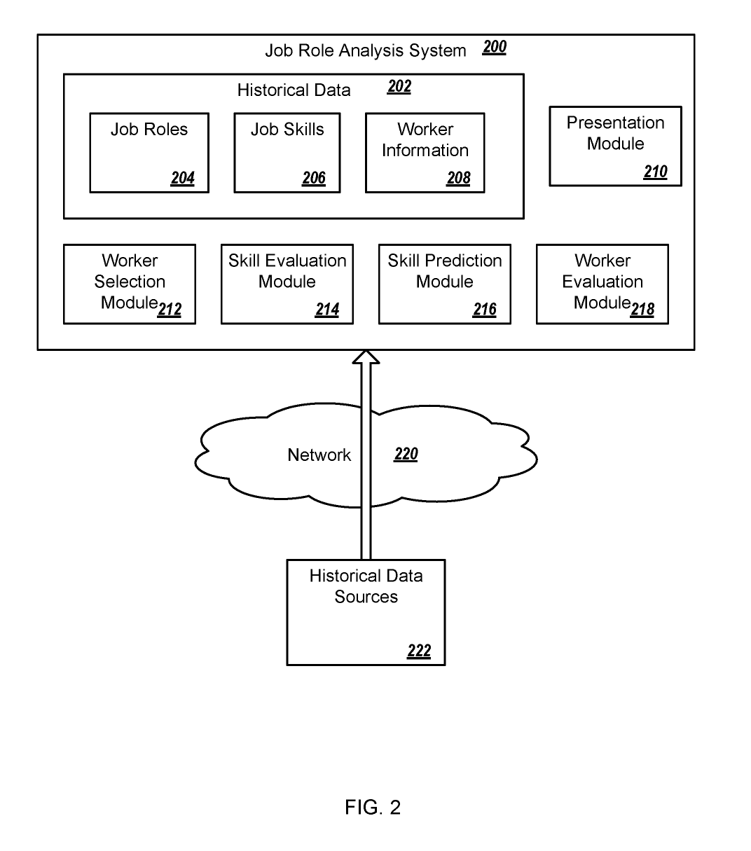

FIG. 2 is an example of a job role analysis system 200 that predicts skills likely to be required for a job role in the future. The job role analysis system 200 includes historical data 202, such as data defining job roles 204, data defining job skills 206, and data defining worker information 208.

One or more databases may store the historical data 202. For instance, a database may include multiple records for data defining job roles 204, multiple records for data defining job skills 206, and multiple records for data defining worker information 208. In some examples, a first database may store data for job roles 204, a second database may store data for job skills 206, and a third database may store data for worker information 208. In some examples, the historical data may include one or two of data for job roles 204, data for job skills 206, and data for worker information 208.

The data defining the job roles 204 may include job titles, job descriptions, and job descriptions for particular industries, e.g., nursing, accounting, and aerospace, among other types of job role data. The data defining the job skills 206 may include names of particular job skills, e.g., Office Suite proficiency and spreadsheet proficiency, descriptions of tasks associated with job skills, and relationships between job skills, e.g., spreadsheet proficiency may be an indication of Office Suite proficiency, potentially in combination with other software skills. The data defining the worker information 208 may include job resumes, descriptions of skills, tasks, or both, performed by workers in particular job roles, e.g., as part of self-evaluations, biographies for workers, and other types of information about a worker and their job skills.

The job role analysis system 200 may receive the historical data 202 from multiple sources including, via a network 220, historical data sources 222. The historical data sources 222 may include a company's biography web pages and other web pages with company information such as job specific information for the company, social networking sites, job posting sites, news web sites, patent databases, programming web sites, e.g., specific to particular projects or source code repositories, and other web sources, to name a few examples. In some implementations, the job role analysis system 200 may receive some of the historical data 202 via input entered by a user, e.g., into a computer. For instance, the job role analysis system 200 may receive data, from the computer, that indicates input identifying a particular worker's current skills, e.g., entered by a corresponding worker or another user of the job role analysis system 200.

The job role analysis system 200 may receive data indicating a request, from a user, for a job role skill prediction. The prediction may be specific to a particular job role. The prediction may be specific to a particular industry, a particular geographic area, a particular worker or group of workers, a particular time in the future, or a combination of two or more of these.

For instance, a presentation module 210 may provide instructions for presentation of a job skill user interface to a computer, operated by the user, to allow the user to select a user interface control that indicates the request for the job role skill prediction, e.g., specific to a particular job role. The presentation module 210 or the job role analysis system 200 may receive the request from the computer and provide the request to a worker selection module 212.

The worker selection module 212 uses the particular job role identified in the request to determine information, from the historical data 202, about workers who worked in the particular job role. For instance, the worker selection module 212 may determine identifiers for the subset of workers that had the particular job role as indicated in the historical data 202, e.g., in the worker information 208.

The worker selection module 212 or a skill evaluation module 214 may determine the skills the subset of workers had when they worked in the particular job role. For example, the worker selection module 212 provides the identifiers for the subset of workers to the skill evaluation module 214 and the skill evaluation module 214 analyzes the worker information 208, the job skills 206, or both, to determine the skills the workers had when they worked in the particular job role.

The worker selection module 212 or the skill evaluation module 214 may use rules to determine the skills the subset of workers had when they worked in the particular job role. For instance, the module may use rules that indicate key words and corresponding skills the worker had or likely had based on the key words.

The skill evaluation module 214 uses the determined skills to identify trends in the skills over time. The skill evaluation module 214 or the worker selection module 212 may group the workers according to a time when the workers had the particular job role. For each of the groups of workers and time periods, the skill evaluation module 214 determines the skills employed by the workers in the particular job role and analyzes the determined skills to identify common skills employed by the workers during that time period.

The time periods may all have the same length, e.g., five or ten years. Some time periods may have different lengths. For instance, the job role analysis system 200, e.g., the skill evaluation module 214, may determine the skills for the particular job role, determine times at which there were significant changes to the skills used in the particular job role, and determine the time periods using the determined times. In some examples, when the skill evaluation module 214 determines that there was a first significant change in the skills used for the particular job role at year X and a second significant change in the skills used for the particular job role at year Y, the skill evaluation module 214 may determine a first time period for the ten years prior to year X, a second time period that starts in year X and ends the year prior to year Y, and a third time period from the year Y, inclusive, to the current time.

The skill evaluation module 214 provides data representing the common skills for each of the time periods to a skill prediction module 216. The skill evaluation module 214 may provide data representing all of the other skills used by workers in the particular job role from a most recent time period to the skill prediction module 216. The skill prediction module 216 uses the data representing the common skills for each of the time periods, and optionally the data representing the other skills used by workers in the particular job role from the most recent time period, to determine a predicted set of skills for a future date. In some examples, the skill prediction module 216 uses data representing all of the skills for the particular job role to determine the predicted set of skills for the future date.

The future date may be defined in the request for the job role skill prediction, e.g., based on data received from input of the user that indicates a particular future date. In some examples, the future date may be predetermined, e.g., five years or another future date defined by an administrator.

The skill prediction module 216 may use regression analysis to determine the predicted set of skills. The skill prediction module 216 may determine a likelihood that each of the skills in the predicted set of skills will be required for the particular job role at the future date. For instance, the skill prediction module 216 may use a current set of skills for the particular job role, as determined by the current skills workers commonly employ for the particular job role, and other skills some of the workers currently employ for the particular job role to determine the likelihood that each of the skills in the predicted set of skills will be required for the particular job role at the future date.

For example, the skill prediction module 216 may select the predicted set of skills from a pool of skills currently used by workers for the particular job role. The skill prediction module 216 may determine whether each of the commonly employed current skills has a likelihood of being employed at the future date that satisfies a threshold value and, if so, include that commonly employed current skill in the predicted set of skills. The skill prediction module 216 may analyze each of the other current skills for the particular job role to determine whether the skill has a likelihood of being employed at the future date and, if the likelihood satisfies the threshold value, include the skill in the predicted set of skills.

In some implementations, the skill prediction module 216 may determine similarities in the particular job role to other job roles, e.g., when a measure of similarity of skills required for the particular job role and the other job roles satisfies a threshold value. The threshold value may be a quantity or a percentage. The skill prediction module 216 may determine some of the skills in the predicted set of skills by analyzing the other job roles that are similar to the particular job role and the skills required or predicted to be required for the other job roles. The skill prediction module may use those skills required or predicted to be required for the other job roles as some of the skills in the predicted set of skills.

In some examples, the skill prediction module 216 may determine that a particular skill is used in a wide variety of job roles, whether or not those job roles have a threshold similarity to the particular job role, and use that particular skill as one of the predicted skills. The skill prediction module 216 may determine that the particular skill is widely used or is a new skill and that the particular skill satisfies a threshold likelihood of being used in the particular job role at the future date.

The skill prediction module 216 may provide the predicted set of skills to the presentation module 210 for presentation to a user. In some examples, the skill prediction module 216 provides the predicted set of skills to a worker evaluation module 218.

The worker evaluation module 218 uses the predicted set of skills to determine whether a particular worker or the workers in a group of workers will have the predicted skills or is likely to learn the predicted skills. For instance, the worker evaluation module 218 compares characteristics for the particular worker, such as education information, skills learned, and classes attended, among other characteristics, with characteristics of other workers to determine a likelihood that the particular worker will be able to learn one of the predicted skills. In some implementations, the evaluation module 218 identifies representative workers that have successfully learned the skills that the particular worker needs to learn, and determines characteristics of the representative workers. The evaluation module 218 then determines whether the particular worker has characteristics matching those who have successfully learned the skills before.

In some examples the set of predicted skills for a role includes Office Suite proficiency, database proficiency, general computer proficiency, and communication skills. The current common skills for the role include Office Suite proficiency, email, and general computer proficiency. A particular employee has document and spreadsheet proficiency, general computer proficiency, and communication skills. In this scenario, the worker evaluation module 218 determines whether the particular worker will likely be able become proficient in all applications of an Office Suite and proficient in the use of databases. The worker evaluation module 218 may compare the skills the particular worker has or has learned after beginning their job, e.g., either their current job or their first data entry job, with the skills of other workers to determine which skills are easily learned and how likely the particular worker is to learn the predicted skills which he currently does not have.

The worker evaluation module 218 may determine a likelihood the worker will have or be able to learn each of the skills which the particular worker does not have, e.g., both Office Suite proficiency and database proficiency, or an overall likelihood that the particular worker will have or be able to learn all of the predicted skills. In some examples, the worker evaluation module 218 determines that most workers are proficient in or become proficient in Office Suite applications and that the particular worker has a likelihood that satisfies a threshold value, e.g., seventy-five percent, of learning the skill or otherwise having the skill by the particular future date.

The worker evaluation module 218 may determine that the particular worker is not likely to become proficient in the use of databases, e.g., because the particular worker had difficulty learning other similar types of software applications in the past or the characteristics of the particular worker indicate a correlation with other workers that have not become proficient in the use of databases. Alternatively, the worker evaluation module 218 may determine that the characteristics of the particular worker are similar to characteristics of other workers that have become or are becoming proficient in the use of databases and that the particular worker is likely to also become proficient in the use of databases. The worker evaluation module 218 may identify certain pre-requisite or foundational skills or characteristics that are generally indicative of success in learning a future skill. These may include, for example, a particular level of education or program of study, a particular level of work experience, or other factors.

In some implementations, the worker evaluation module 218 may determine a likelihood that a group of workers will have or will be able to learn the predicted skills, e.g., similar to the determination for a particular worker. The group of workers may be a particular group, e.g., which live in a particular geographic area or currently work for a particular entity.

The worker evaluation module 218 provides data to the presentation module 210 that indicates the likelihood the particular worker or the group of workers will have the predicted skills to allow a user to make a determination using the likelihood. For instance, when the user is a prospective supervisor of a job applicant for a job role, the supervisor may use the likelihood to determine whether the job applicant is a good fit for the job role.

In some examples, a user may determine where to open a new store or build an office or production facility using the likelihood that a group of workers will have or can learn the predicted skills. For example, the worker evaluation module 218 may determine the likelihood that a particular labor market will have enough workers for multiple different positions required to open a production facility. The worker evaluation module 218 may analyze workers in multiple different labor markets to determine a best fit geographic location for the production facility, e.g., that has the most workers likely to have or learn the predicted skills, that has at least a required number of workers for each of the job roles, that has a lowest cost of workers, or a combination of two or more of these. The worker evaluation module 218 provides information about the particular labor market or multiple different labor markets to the presentation module 210. The presentation module 210 generates instructions for presentation of a user interface to cause the presentation of the information to a user.

The worker evaluation module 218 may determine, for a particular worker, e.g., analyzed alone or as part of a group of workers, that the particular worker has some of the predicted skills, can learn some of the predicted skills, will not know and is not likely to learn some of the skills, or a combination of these. For instance, the worker evaluation module 218 may determine that a first worker has two of the three predicted skills and is not likely to learn a third and that a second worker does not currently have any of the predicted skills but is likely to learn all three.

In some examples, the worker evaluation module 218, or another component of the job role analysis system 200, may analyze tasks performed by a worker to determine the corresponding skills used by the worker. For example, the worker evaluation module 218 may determine that a resume for a particular worker lists “send weekly status updates to client” and “present job proposals” and determine that the particular worker had communication skills for a corresponding job role.

The network 220, such as a local area network (LAN), wide area network (WAN), the Internet, or a combination thereof, connects the job role analysis system 200 and the historical data sources 222.

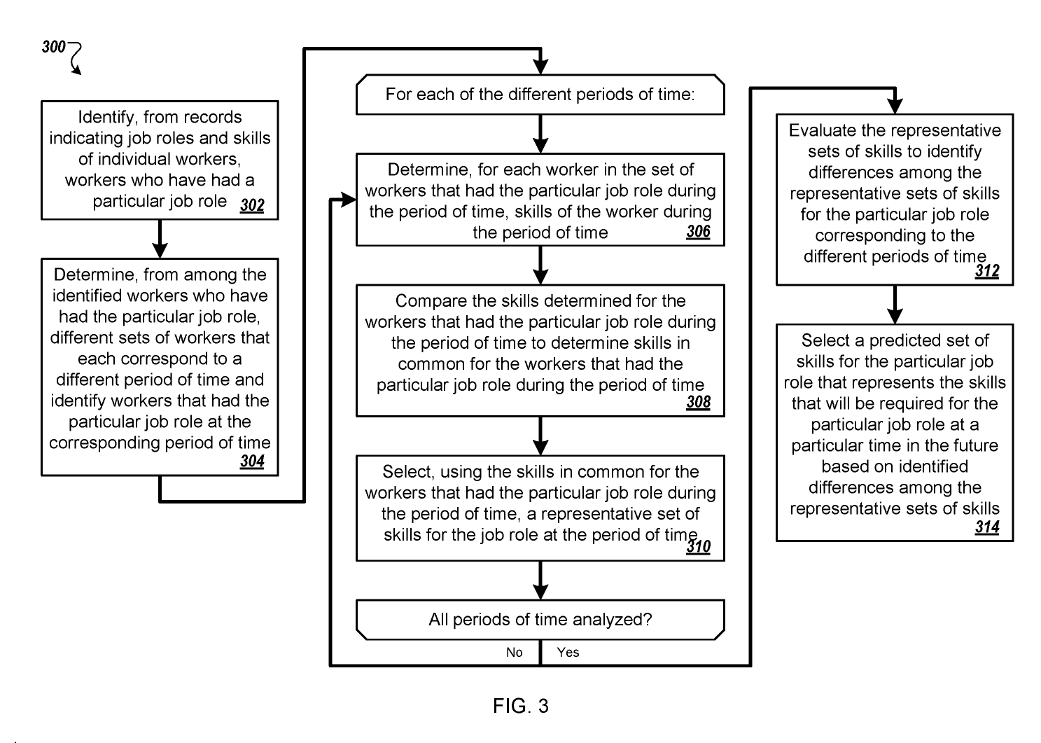

FIG. 3 is a flow diagram of a process 300 for selecting a predicted set of skills for a particular job role. For example, the process 300 can be used by the job role analysis system 200.

The system identifies, from records indicating job roles and skills of individual workers, workers who have had a particular job role (302). In some examples, the workers are workers in a particular industry, particular geographic area, or both. The system may determine one or more related job roles that include, or previously included, similar skills, tasks, or both, to the particular job role.

In some implementations, the system may determine entities that provide products or services in the particular industry. The system may analyze information about the entities, e.g., changes in job role titles, to determine related job roles. For instance, the system may determine that a particular job role, e.g., data entry, had a different name in the past, e.g., record keeping, and determine workers for that job role with a different name.

The system determines, from among the identified workers who have had the particular job role, different sets of workers that each correspond to a different period of time and identify workers that had the particular job role at the corresponding period of time (304). For example, the system determines identifiers for the workers in a database with historical data, determines different job roles each of the workers had, and times at which the workers had each of the job roles. The system determines which of the workers had or have the particular job role and a time period or multiple time periods during which the worker had that job role.

The system may determine that a particular worker had the particular job role for multiple different time periods, e.g., when a time period is ten years and the particular worker had the job role for thirty-three years. The system may determine which skills the particular worker used during each of the different time periods and associate those skills with the corresponding time period.

For each of the different periods of time, the system determines, for each worker in the set of workers that had the particular job role during the period of time, skills of the worker during the period of time (306). The system may determine the skills using resumes or other types of information for the workers. In some examples, the system may determine tasks performed by one or more of the workers while performing the job role and the skills required for those tasks.

For each of the different periods of time, the system compares the skills determined for the workers that had the particular job role during the period of time to determine skills in common for the workers that had the particular job role during the period of time (308). For instance, the system determines all of the skills used by the workers in a particular time period. The system determines, for each of the skills a quantity of workers that used the skill.

For each of the different periods of time, the system selects, using the skills in common for the workers that had the particular job role during the period of time, a representative set of skills for the job role at the period of time (310). If the quantity satisfies a threshold value, e.g., is greater than fifty percent of the workers for the corresponding time period, the system includes the corresponding skill in the representative set of skills. In some examples, the system may determine that two skills are related, e.g., typewriter entry and word processor entry, and combine the two skills when determining the representative set of skills.

After analyzing each of the different periods of time, the system evaluates the representative sets of skills to identify differences among the representative sets of skills for the particular job role corresponding to the different periods of time (312). For example, the system analyzes the representative sets of skills to determine changes to the skills used in the particular job role over time.

The system selects a predicted set of skills for the particular job role that represents the skills that will be required for the particular job role at a particular time in the future based on identified differences among the representative sets of skills (314). For instance, the system determines that some of the predicted set of skills have been used by workers throughout all of the periods of time, e.g., and are included in all of the representative sets of skills, and include those skills in the predicted set of skills. In some examples, the system determines particular skills that have been included in a threshold quantity of the most recent periods of time and include those particular skills in the predicted set of skills. The system may use any appropriate method to determine the predicted set of skills.

In some implementations, the system determines new skills in a current period of time that are not included in previous periods of time and a likelihood that each of the new skills will be used in the particular job role at the particular time in the future. If the likelihood that a particular new skill satisfies a threshold value, the system includes the new skill in the predicted set of skills.

In some examples, the predicted set of skills may be for the particular industry, the particular geographic area, or both. In some implementations, the system may determine that skills used in a first industry often are used in a second industry before the first industry. The system may determines some of the skills in the predicted set of skills in the first industry using the skills for the second industry.

The order of steps in the process 300 described above is illustrative only, and selecting the predicted set of skills for the particular job role can be performed in different orders. For example, the system may determine the skills for each of the workers and then determine the skills used for each time period. In these examples, while the system determines the skills used for each time period, the system determines the quantity of workers who used the skill for the corresponding time period.

In some implementations, the process 300 can include additional steps, fewer steps, or some of the steps can be divided into multiple steps. For example, the process 300 may include one or more steps or features from the process 400 described in detail below.

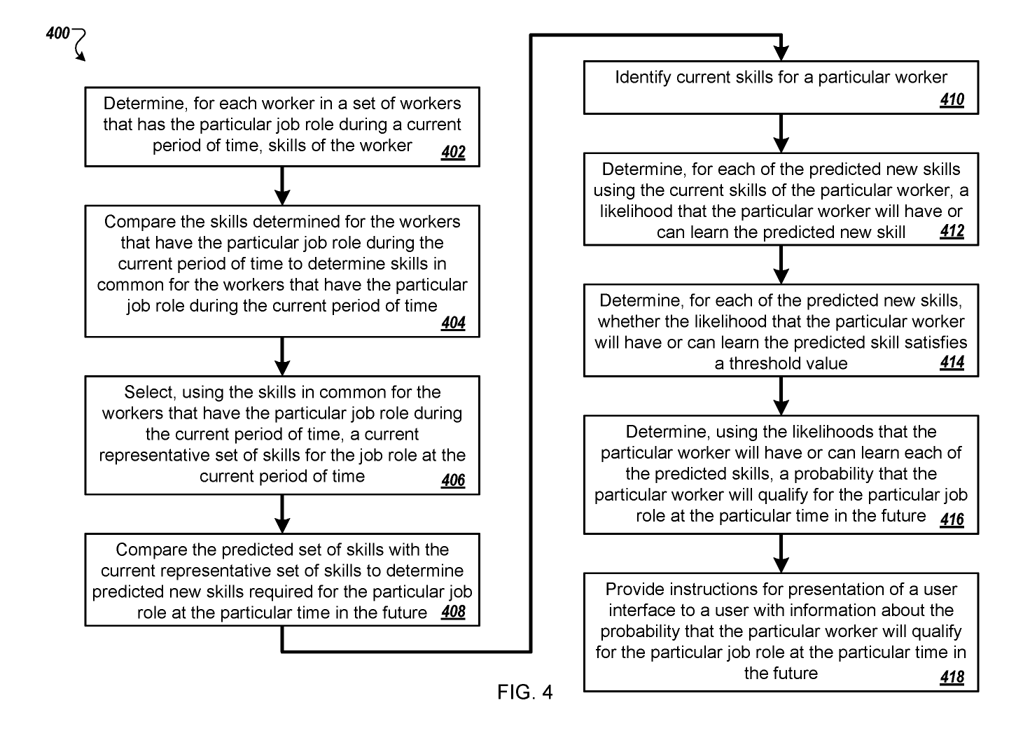

FIG. 4 is a flow diagram of a process 400 for determine predicted new skills required for a particular job role at a particular time in the future. For example, the process 400 can be used by the job role analysis system 200.

The system determines, for each worker in a set of workers that has the particular job role during a current period of time, skills of the worker (402). For instance, the system determines workers that are currently employed with a position in the job role. The system may determine workers that work in a particular field, geographic area, for a particular entity or group of entities, or two or more of these.

The system compares the skills determined for the workers that have the particular job role during the current period of time to determine skills in common for the workers that have the particular job role during the current period of time (404). For instance, the system determines the skills used by the workers currently in their position in the particular job role.

The system selects, using the skills in common for the workers that have the particular job role during the current period of time, a current representative set of skills for the job role at the current period of time (406). For example, the system determines the current skills that are typically required in the particular job role. The current skills may be for a particular field, geographic area, for a particular entity or group of entities, or two or more of these.

The system compares the predicted set of skills with the current representative set of skills to determine predicted new skills required for the particular job role at the particular time in the future (408). The system determines the skills that workers will likely need to learn if they don't already know one of the predicted new skills and plan to continue to work in the particular job role. In some implementations, the system may determine the skills that are not likely to be used by the particular job role in the future.

The system identifies current skills for a particular worker (410). For instance, the system may analyze the particular worker to determine the likelihood that the particular worker will have or learn the skills predicted to be used in the particular job role in the future. In some examples, the system may analyze each worker in a group of workers to determine a size of a potential worker applicant pool, the predicted number of workers that will need to learn particular skills to continue working in the particular job role, or a percentage of workers predicted to have or be able to learn the predicted skills for the particular job role, among other types of analysis for a group of workers.

The system determines, for each of the predicted new skills using the current skills of the particular worker, a likelihood that the particular worker will have or can learn the predicted new skill (412). For example, the system may use the worker's age, training, education, previous job roles, job history, geographic location in which the worker lives, type of degree, and other types of characteristics, to determine the likelihood that the worker will have or can learn the predicted new skill. The likelihood may be a likelihood that the particular worker will have the predicted new skills by the particular time in the future when the particular job role is predicted to use the predicted new skills.

In some implementations, the system may use the skills of other workers to determine the likelihood that the particular worker will have or can learn the predicted new skills. For example, the system may identify workers that each have all of the current skills, and determine characteristics for the identified workers. The system compares the characteristics for the identified workers with the characteristics of a particular worker to determine the likelihood that the particular worker will have or can learn the predicted new skills. If the system determines that more than a threshold value of characteristics are the same, the system determines that the particular worker is more likely to have the predicted new skills. If the system determines that less than the threshold value of characteristics are the same, the system determines that the particular worker is less likely to have the predicted new skills. The likelihood that the particular worker will have or can learn the predicted new skills can be based on a degree of similarity between the characteristics. In some examples, the system identifies other workers that have the predicted new skills and the characteristics of those workers.

In some implementations, the system determines skills that have changed over time for a group of workers that have had the particular job role, either currently or in the past. The system determines workers whose skills have changed over time and characteristics of those workers. The system compares those characteristics, which have a likelihood of being representative of characteristics for workers who can generally learn new skills, with the characteristics of the particular worker to determine the likelihood that the particular worker will have or can learn the predicted new skills, e.g., using the degree of similarity between the characteristics of the workers whose skills changed over time and the characteristics of the particular worker.

The system determines, for each of the predicted new skills, whether the likelihood that the particular worker will have or can learn the predicted skill satisfies a threshold value (414). For instance, the system determines whether there is at least a seventy-five percent chance that the worker will have the predicted new skill by the particular time in the future or can learn the predicted new skill.

The system determines, using the likelihoods that the particular worker will have or can learn each of the predicted skills, a probability that the particular worker will qualify for the particular job role at the particular time in the future (416). For example, the system determines the probability that the particular worker will make a transition from the current skills for the particular job role to predicted requirements for the particular job role in the future.

The system provides instructions for presentation of a user interface to a user with information about the probability that the particular worker will qualify for the particular job role at the particular time in the future (418). For instance, the system provides the instructions to a user device. The user device presents the user interface to a user, e.g., to allow the user to make a decision about the particular worker, a group of workers that includes the particular worker, or another decision for an entity, such as where to open a new location. For example, the user interface may include a recommendation indicating in which geographic region the entity should open an office, an estimated cost for employing or training the particular worker, whether to hire the worker, or a combination of two or more of these. The user who views the user interface may be a different person than the particular worker.

In some examples, the particular worker may view information about the probability, the predicted new skills, or both. For instance, the user interface may provide the particular worker with information about which classes he should attend to maintain the skills necessary for the particular job role, suggested certifications, and other types of continuing education. The system may determine the predicted new skills that are not included in the particular worker's current skills and provide information about those skills to the worker. In some examples, the system may provide a recommended completion date by which the particular worker should complete recommended training, classes, or certifications.

The order of steps in the process 400 described above is illustrative only, and determine predicted new skills required for the particular job role at the particular time in the future can be performed in different orders. For example, the system may identify the current skills for the particular worker, e.g., step 410, and then determine the predicted new skills required for the particular job role at the particular time in the future, e.g., step 408 or a combination of two or more of steps 402 through 408.

In some implementations, the process 400 can include additional steps, fewer steps, or some of the steps can be divided into multiple steps. For example, a system may perform steps 402 through 408 without performing steps 410 through 418. In some examples, a system may perform steps 408 through 418 without performing steps 402 through 406.

In some implementations, a system may perform all or part of the process 300, all or part of the process 400, or both, for a group of people. For instance, the system may predict an overall percentage of people in the group of people that will have or can learn predicted skills for a particular job role. The system may determine a likelihood for each person in the group of people that the person will have each of the predicted new skills or all of the predicted new skills or both. The system may provide information about the overall percentage to a user, e.g., the overall percentage or a recommendation as to a particular geographic area in which to build or open a new store or building.

In some examples, when the system provides a user interface with information about a group of workers, the user interface may include an option to filter the information by geographic location, industry, internal or external employee, e.g., whether or not an employee is currently employed by a particular entity or not, or another type of filter. For instance, the user interface may allow a manager to view information about a group of workers in a particular geographic area and a subset of that group that currently workers for the company that employs the manager.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory program carrier for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A computer-implemented method comprising:
identifying, by a computing system in communication with one or more data storage devices storing records indicating job roles and skills of individual workers, workers who have had a particular job role;
determining, by the computing system and from among the identified workers who have had the particular job role, different sets of workers wherein each set corresponds to a different period of time and identifies workers that had the particular job role during the corresponding period of time;
for each of the different periods of time:
determining, by the computing system and for each worker in the set of workers that had the particular job role during the period of time, skills of the worker during the period of time;
comparing, by the computing system, the skills determined for the workers that had the particular job role during the period of time to determine skills in common for the workers that had the particular job role during the period of time; and
selecting, by the computing system and using the skills in common for the workers that had the particular job role during the period of time, a representative set of skills for the job role at the period of time, the representative set of skills comprising skills most commonly possessed by workers having the particular job role during the period of time;
evaluating, by the computing system, the representative sets of skills to identify differences among the representative sets of skills for the particular job role corresponding to the different periods of time; and
based on identified differences among the representative sets of skills, selecting, by the computing system, a predicted set of skills for the particular job role that represents the skills that will be required for the particular job role at a particular time in the future.

2. The method of claim 1, comprising:
determining, for each worker in the set of workers that has the particular job role during a current period of time, second skills of the worker;
comparing the second skills determined for the workers that have the particular job role during the current period of time to determine second skills in common for the workers that have the particular job role during the current period of time;
selecting, using the second skills in common for the workers that have the particular job role during the current period of time, a current representative set of skills for the job role at the current period of time; and
comparing the predicted set of skills with the current representative set of skills to determine predicted new skills required for the particular job role at the particular time in the future.

3. The method of claim 2, comprising:
identifying current skills for a particular worker;
determining, for each of the predicted new skills and using the current skills of the particular worker, a likelihood that the particular worker will have or can learn the predicted new skill;
determining, for each of the predicted new skills, whether the likelihood that the particular worker will have or can learn the predicted skill satisfies a threshold value;
determining, using the likelihoods that the particular worker will have or can learn each of the predicted skills, a probability that the particular worker will qualify for the particular job role at the particular time in the future; and
providing instructions for presentation of a user interface with information about the probability that the particular worker will qualify for the particular job role at the particular time in the future.

4. The method of claim 3, wherein determining the likelihood that the particular worker will have or can learn the predicted new skill comprises:
determining a set of comparison workers each of which (i) has each of the skills in the current representative set of skills and (ii) previously did not have one of the skills in the current representative set of skills;
comparing characteristics of the particular worker with characteristics of the comparison workers to determine a degree of similarity between the characteristics of the particular worker and the characteristics of the comparison workers; and
determining the likelihood that the particular worker will have or can learn the predicted new skill using the degree of similarity between the characteristics of the particular worker and the characteristics of the comparison workers.

5. The method of claim 3, wherein determining the likelihood that the particular worker will have or can learn the predicted new skill comprises:
determining, for each worker in a particular set of workers that have had the particular job role, whether a set of skills for the worker has changed over time;
comparing the characteristics of the particular worker with characteristics of the workers that each has a set of skills that changed over time to determine a degree of similarity between the characteristics of the particular worker and the characteristics of the workers in the particular set; and
determining the likelihood that the particular worker will have or can learn the predicted new skill using the degree of similarity between the characteristics of the particular worker and the characteristics of the workers in the particular set.

6. The method of claim 3, wherein determining, for each of the predicted new skills using the current skills of the particular worker, the likelihood that the particular worker will have or can learn the predicted new skill comprises determining, for each worker in a group of workers and for each of the predicted new skills, a likelihood that the worker will have or can learn the predicted new skill.

7. The method of claim 3, wherein:
identifying the current skills for the particular worker comprises identifying the current skills of a prospective employee; and
determining, for each of the predicted new skills and using the current skills of the particular worker, the likelihood that the particular worker will have or can learn the predicted new skill comprises:
determining which skills in the current representative set of skills the prospective employee has; and
determining, for each of the predicted new skills, a likelihood that the prospective employee will have or can learn the predicted skill using the skills in the current representative set of skills that the prospective employee has and background information of the prospective employee.

8. The method of claim 3, wherein determining, for each of the predicted new skills using the current skills of the particular worker, the likelihood that the particular worker will have or can learn the predicted new skill comprises determining, for each of the predicted new skills, the likelihood that the particular worker will have or can learn the predicted skill using one or more of an education of the particular worker, a geographic location in which the particular worker lives, or a job history of the particular worker.

9. The method of claim 3, comprising:
providing, for each of the predicted new skills that (i) has a respective likelihood that satisfies the threshold value and (ii) is not one of the current skills of the particular worker, instructions for presentation of a user interface with information about an activity in which the particular worker can participate to acquire the predicted skill.

10. The method of claim 1, comprising:
identifying, from records indicating job descriptions, a set of job descriptions for the particular job role; and
determining, for each job description in the set of job descriptions, one of the different periods of time during which the job description was posted, wherein for each of the different periods of time, selecting the representative set of skills for the job role at the period of time comprises:
determining, for each of the job descriptions for the period of time, second skills listed on the job description;
comparing the second skills to determine second skills in common for the job descriptions for the period of time; and
selecting the representative set of skills for the job role at the period of time using the second skills in common between the job descriptions for the period of time.

11. The method of claim 1, wherein selecting the representative set of skills for the job role at the period of time comprises:
determining, for each of the skills determined for the workers that had the particular job role during the period of time, whether a measure of workers who had the skill satisfies a threshold value; and
including, for each of the skills for which a measure of workers who had the skill satisfied the threshold value, the skill in the representative set of skills for the job role at the period of time.

12. The method of claim 1, wherein:
evaluating the representative sets of skills to identify the differences among the representative sets of skills for the particular job role corresponding to the different periods of time comprises:
determining a frequency at which changes to the representative set of skills for the particular job role occurred over the different periods of time; and
selecting the predicted set of skills for the particular job role that represents the skills that will be required for the particular job role at the particular time in the future comprises:
determining, using the frequency at which the changes to the representative set of skills occurred over the different periods of time for each skill in the representative sets of skills, a likelihood that the skill will be required for the particular job role at the particular time in the future; and
determining, for each of the skills, whether the likelihood satisfies a threshold value; and
selecting, for each of the skills with a respective likelihood that satisfies the threshold value, the skill as a predicted skill in the predicted set of skills.

13. A system comprising:
a data processing apparatus; and
a non-transitory computer readable storage medium in data communication with the data processing apparatus and storing instructions executable by the data processing apparatus and upon such execution cause the data processing apparatus to perform operations comprising:
identifying, by a computing system in communication with one or more data storage devices storing records indicating job roles and skills of individual workers, workers who have had a particular job role;
determining, by the computing system and from among the identified workers who have had the particular job role, different sets of workers wherein each set corresponds to a different period of time and identifies workers that had the particular job role during the corresponding period of time;
for each of the different periods of time:
determining, by the computing system and for each worker in the set of workers that had the particular job role during the period of time, skills of the worker during the period of time;
comparing, by the computing system, the skills determined for the workers that had the particular job role during the period of time to determine skills in common for the workers that had the particular job role during the period of time; and
selecting, by the computing system and using the skills in common for the workers that had the particular job role during the period of time, a representative set of skills for the job role at the period of time, the representative set of skills comprising skills most commonly possessed by workers having the particular job role during the period of time;
evaluating, by the computing system, the representative sets of skills to identify differences among the representative sets of skills for the particular job role corresponding to the different periods of time; and
based on identified differences among the representative sets of skills, selecting, by the computing system, a predicted set of skills for the particular job role that represents the skills that will be required for the particular job role at a particular time in the future.

14. A non-transitory computer readable storage medium storing instructions executable by a data processing apparatus and upon such execution cause the data processing apparatus to perform operations comprising:
identifying, by a computing system in communication with one or more data storage devices storing records indicating job roles and skills of individual workers, workers who have had a particular job role;
determining, by the computing system and from among the identified workers who have had the particular job role, different sets of workers wherein each set corresponds to a different period of time and identifies workers that had the particular job role during the corresponding period of time;
for each of the different periods of time:
determining, by the computing system and for each worker in the set of workers that had the particular job role during the period of time, skills of the worker during the period of time;
comparing, by the computing system, the skills determined for the workers that had the particular job role during the period of time to determine skills in common for the workers that had the particular job role during the period of time; and
selecting, by the computing system and using the skills in common for the workers that had the particular job role during the period of time, a representative set of skills for the job role at the period of time, the representative set of skills comprising skills most commonly possessed by workers having the particular job role during the period of time;
evaluating, by the computing system, the representative sets of skills to identify differences among the representative sets of skills for the particular job role corresponding to the different periods of time; and
based on identified differences among the representative sets of skills, selecting, by the computing system, a predicted set of skills for the particular job role that represents the skills that will be required for the particular job role at a particular time in the future.
